(19) United States
(12) Patent Application Publication
(10) Pub. No.: US 2014/0116745 A1
(43) Pub. Date: May 1, 2014

(54) Two Piece Condulets

(71) Applicants: Jason Fortune, Clyde, TX (US); Wade Parker, Abilene, TX (US)

(72) Inventors: Jason Fortune, Clyde, TX (US); Wade Parker, Abilene, TX (US)

(21) Appl. No.: 13/666,348

(22) Filed: Nov. 1, 2012

(51) Int. Cl. H02G 3/04

(52) U.S. Cl. CPC H02G 3/0406
USPC 174/68.3

(57) ABSTRACT

A conduit for protecting wires may include an only top curved wall and an only bottom curved wall being connected to the top curved wall to define a housing for the conduit and having a cavity. The top curved wall may include a top flange. The bottom curved wall may include a bottom flange.

### FIELD OF THE INVENTION

The present invention relates to condulets and more particularly to a two piece condulet.

### BACKGROUND

Conduit bodies are commonly referred to as condulets, a term trademarked by Cooper Crouse-Hinds company, a division of Cooper Industries. An electrical conduit is an electrical piping system used for protection and routing of electrical wiring. Electrical conduit may be made of metal, plastic, fiber, or fired clay. Flexible conduit is available for special purposes.

Conduit is generally installed by electricians at the site of installation of electrical equipment. Its use, form, and installation details are often specified by wiring regulations, such as the US National Electrical Code (NEC) or other national or local code. The term “conduit” is commonly used by electricians to describe any system that contains electrical conductors, but the term may have a more restrictive definition when used in wiring regulations.

Some early electric lighting installations made use of existing gas pipe to gas light fixtures which had been converted to electric lamps. Since this technique provided very good mechanical protection for interior wiring, it was extended to all types of interior wiring and by the early 20th century purpose-built couplings and fittings were manufactured for electrical use.

During typical construction, a length of conduit extends generally between point where wires are to be connected. The conduit may be a continuous cylinder having a hollow center for the placement of the wires. These conduits provide adequate protection for the wires against invasion of all types articles which could adversely affect the operation of the wires.

However, from time to time, a defect may occur with one or more of the wires within the conduit. In order to identify and correct the defect, the conduit may be required to be removed or replaced or at the very least a hole has to be made in the side of the conduit in order to reach the defect. This hole should then be repaired. In the alternative, the wires must be removed from the conduit and replaced with new wire.

This requires a large amount of manpower and cost.

### SUMMARY

A conduit for protecting wires may include an only top curved wall and an only bottom curved wall being connected to the top curved wall to define a housing for the conduit and having a cavity.

The top curved wall may include a top flange.

The bottom curved wall may include a bottom flange.

The top curved wall may be substantially L-shaped.

The top curved wall may be substantially T-shaped.

The top curved wall may be substantially rectangular.

The bottom curved wall may be substantially L-shaped.

The bottom curved wall may be substantially T-shaped.

The bottom curved wall may be substantially rectangular.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of a two-piece conduit L-shaped fitting of the present invention;

FIG. 2 illustrates a end view of the two-piece conduit L-shaped fitting of the present invention;

FIG. 3 illustrates a front view of the two-piece conduit L-shaped fitting of the present invention;

FIG. 4 illustrates another end view of the two-piece conduit L-shaped fitting of the present invention;

FIG. 5 illustrates another end view of the two-piece conduit L-shaped fitting of the present invention;

FIG. 6 illustrates a front view of the two-piece conduit L-shaped fitting of the present invention;

FIG. 7 illustrates another end view of the two-piece conduit L-shaped fitting of the present invention;

FIG. 8 illustrates a sectional view of the two-piece conduit L-shaped fitting of the present invention;

FIG. 9 illustrates a sectional view of the two-piece conduit L-shaped fitting of the present invention;

FIG. 10 illustrates a top view of a two-piece conduit rectangular shaped fitting of the present invention;

FIG. 11 illustrates a end view of the two-piece conduit rectangular shaped fitting of the present invention;

FIG. 12 illustrates a front view of the two-piece conduit rectangular shaped fitting of the present invention;

FIG. 13 illustrates another end view of the two-piece conduit rectangular shaped fitting of the present invention;

FIG. 14 illustrates another end view of the two-piece conduit rectangular shaped fitting of the present invention;

FIG. 15 illustrates a front view of the two-piece conduit rectangular shaped fitting of the present invention;

FIG. 16 illustrates another end view of the two-piece conduit rectangular shaped fitting of the present invention;

FIG. 17 illustrates a sectional view of the two-piece conduit rectangular shaped fitting of the present invention;

FIG. 18 illustrates a top view of a two-piece conduit T-shaped fitting of the present invention;

FIG. 19 illustrates a end view of the two-piece conduit T-shaped fitting of the present invention;

FIG. 20 illustrates a front view of the two-piece conduit T-shaped fitting of the present invention;

FIG. 21 illustrates another end view of the two-piece conduit T-shaped fitting of the present invention;

FIG. 22 illustrates another end view of the two-piece conduit T-shaped fitting of the present invention;

FIG. 23 illustrates a front view of the two-piece conduit T-shaped fitting of the present invention;

FIG. 24 illustrates another end view of the two-piece conduit T-shaped fitting of the present invention;

FIG. 25 illustrates a sectional view of the two-piece conduit T-shaped fitting of the present invention;

FIG. 26 illustrates a top view of a two-piece conduit with external male threads of the present invention;

FIG. 27 illustrates a end view of the two-piece conduit with external male threads of the present invention;

FIG. 28 illustrates a front view of the two-piece conduit with external male threads of the present invention;

FIG. 29 illustrates another end view of the two-piece conduit with external male threads of the present invention;

FIG. 30 illustrates another end view of the two-piece conduit with external male threads of the present invention;

FIG. 31 illustrates a front view of the two-piece conduit with external male threads of the present invention;

FIG. 32 illustrates another end view of the two-piece conduit with external male threads of the present invention;

FIG. 33 illustrates a sectional view of the two-piece conduit with external male threads of the present invention;

FIG. 34 illustrates a sectional view of the two-piece conduit with external male threads of the present invention;

FIG. 35 illustrates a side view of the two-piece conduit elbow fitting of the present invention;

FIG. 36 illustrates a front view of the two-piece conduit elbow fitting of the present invention;

FIG. 37 illustrates a side view of the two-piece conduit elbow fitting of the present invention;

FIG. 38 illustrates a bottom view of the two-piece conduit elbow fitting of the present invention;

### DETAILED DESCRIPTION

When the present invention discusses two-piece conduit, the present invention means only two-piece conduit except where otherwise noted. The two piece conduit may be formed from metal including iron and steel, plastic or other appropriate material for a conduit.

The present invention may repair broken fittings caused during the course of production, may be used to branch off from the main line, may be used to accommodate new service and may be used to install conduit in tight spots where turn radius is limited.

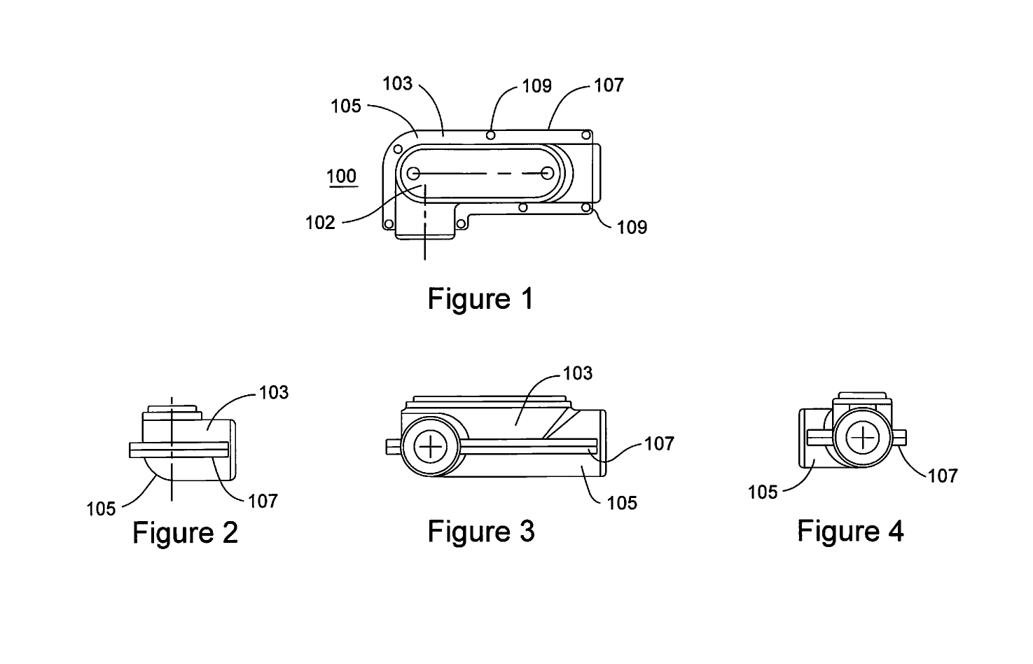

FIG. 1 illustrates a top view of the two-piece conduit L shaped fitting which may include a top curved wall 103 which may include a cover wall 4 and which may be an arched L-shaped wall and a bottom curved wall 105 which may be an arched L-shaped wall to connect to the top curved wall 103. The top curved wall 103 may include a top flange 1 to connect to a bottom flange 107 of the bottom curved wall 105. The housing 100 which may be hollow may define a cavity 102. The top flange 1 and the bottom flange 107 may include apertures 109 to cooperate with a fastener 2 which may be a screw, bolt or other fastener device to connect the top curved wall 103 with the bottom curved wall 105.

A portion of the interior surface at each end of the top curved wall 103 and the bottom curved wall 105 may include female threads 3 to cooperate with male threads (not shown) of another conduit (not shown). Additionally, an adhesive or o ring 5 may be positioned between the top flange 1 and the bottom flange 107.

FIG. 2 illustrates a end view of the two-piece conduit L shaped fitting which may include a top curved wall 103 which may include a cover wall 4 and which may be an arched L-shaped wall and a bottom curved wall 105 which may be an arched L-shaped wall to connect to the top curved wall 103. The top curved wall 103 may include a top flange 1 to connect to a bottom flange 107 of the bottom curved wall 105. The top flange 1 and the bottom flange 107 may include apertures 109 to cooperate with a fastener 2 which may be a screw, bolt or other fastener device to connect the top curved wall 103 with the bottom curved wall 105.

A portion of the interior surface at each end of the top curved wall 103 and the bottom curved wall 105 may include female threads 3 to cooperate with male threads (not shown) of another conduit (not shown). Additionally, an adhesive or o ring 5 may be positioned between the top flange 1 and the bottom flange 107.

FIG. 3 illustrates a front view of the two-piece conduit L shaped fitting which may include a top curved wall 103 which may include a cover wall 4 and which may be an arched L-shaped wall and a bottom curved wall 105 which may be an arched L-shaped wall to connect to the top curved wall 103. The top curved wall 103 may include a top flange 1 to connect to a bottom flange 107 of the bottom curved wall 105. The top flange 1 and the bottom flange 107 may include apertures 109 to cooperate with a fastener 2 which may be a screw, bolt or other fastener device to connect the top curved wall 103 with the bottom curved wall 105.

A portion of the interior surface at each end of the top curved wall 103 and the bottom curved wall 105 may include female threads 3 to cooperate with male threads (not shown) of another conduit (not shown). Additionally, an adhesive or o ring 5 may be positioned between the top flange 1 and the bottom flange 107.

FIG. 4 illustrates a top view of the two-piece conduit L shaped fitting which may include a top curved wall 103 which may include a cover wall 4 and which may be an arched L-shaped wall and a bottom curved wall 105 which may be an arched L-shaped wall to connect to the top curved wall 103. The top curved wall 103 may include a top flange 1 to connect to a bottom flange 107 of the bottom curved wall 105. The top flange 1 and the bottom flange 107 may include apertures 109 to cooperate with a fastener 2 which may be a screw, bolt or other fastener device to connect the top curved wall 103 with the bottom curved wall 105.

A portion of the interior surface at each end of the top curved wall 103 and the bottom curved wall 105 may include female threads 3 to cooperate with male threads (not shown) of another conduit (not shown). Additionally, an adhesive or o ring 5 may be positioned between the top flange 1 and the bottom flange 107.

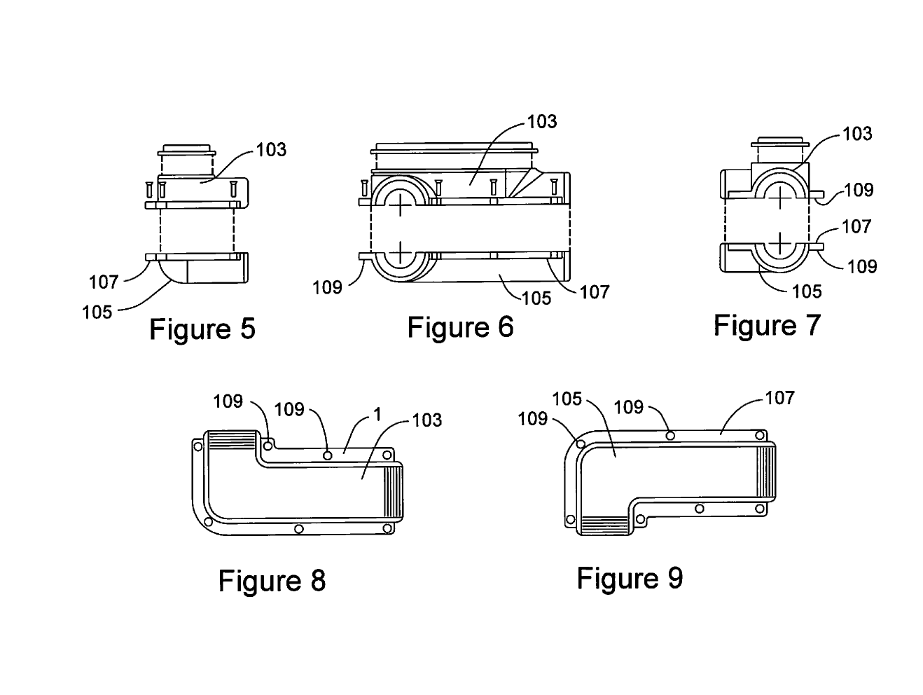

FIG. 5 illustrates an exploded end view of the two-piece conduit L-shaped fitting and illustrates the top curved wall 103, the top flange 1, the fasteners 2 the female threads 3, the cover wall 4, the bottom curved wall 105, the bottom flange 107 and the aperture 109.

FIG. 6 illustrates an exploded front view of the two-piece conduit L-shaped fitting and illustrates the top curved wall 103, the top flange 1, the fasteners 2 the female threads 3, the cover wall 4, the bottom curved wall 105, the bottom flange 107 and the aperture 109.

FIG. 7 illustrates an exploded front view of the two-piece conduit L-shaped fitting and illustrates the top curved wall 103, the top flange 1, the fasteners 2 the female threads 3, the cover wall 4, the bottom curved wall 105, the bottom flange 107 and the aperture 109.

FIG. 8 illustrates a sectional view of the top curved wall 103, the top flange 1, the female threads 3, and the adhesive or O-ring 5.

FIG. 9 illustrates a sectional view of the bottom curved wall 105, the bottom flange 107, the female threads 3, and the adhesive or O-ring 5.

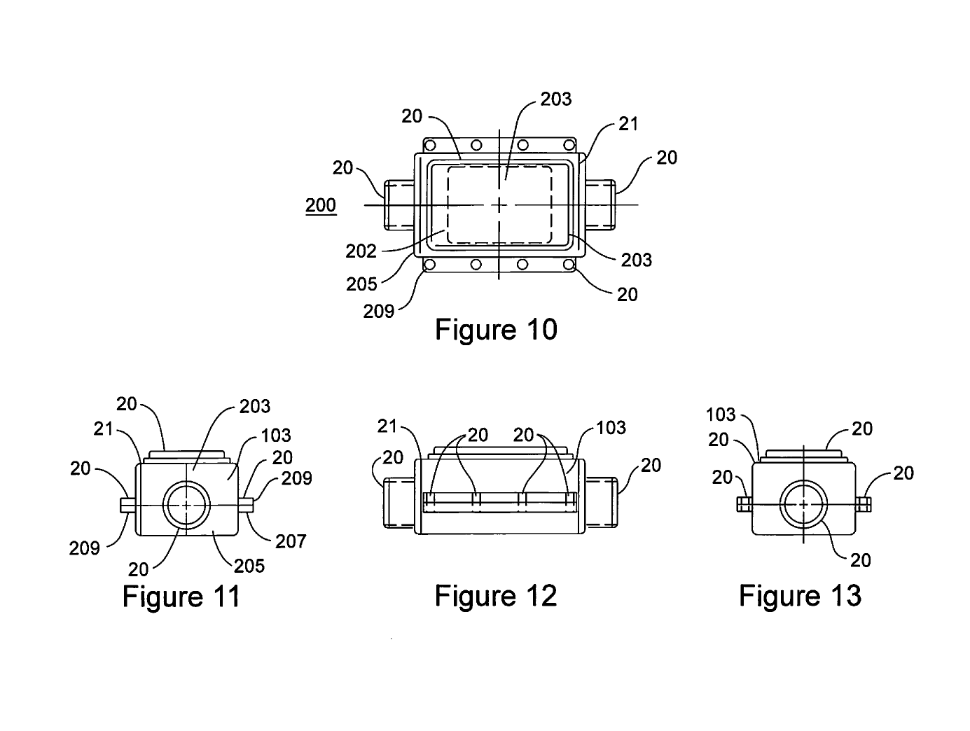

FIG. 10 illustrates a top view of the two-piece conduit rectangular shaped fitting which may include a top curved wall 203 which may include a cover wall 24 and which may be an arched rectangular wall and a bottom curved wall 205 which may be an arched rectangular wall to connect to the top curved wall 203. The housing 200 which may be hollow may define a cavity 202. The top curved wall 203 may include a top flange 21 to connect to a bottom flange 207 of the bottom curved wall 205. The top flange 21 and the bottom flange 207 may include apertures 209 to cooperate with a fastener 22 which may be a screw, bolt or other fastener device to connect the top curved wall 203 with the bottom curved wall 205.

A portion of the interior surface at each end of the top curved wall 203 and the bottom curved wall 205 may include female threads 23 to cooperate with male threads (not shown) of another conduit (not shown). Additionally, an adhesive or o ring 25 may be positioned between the top flange 1 and the bottom flange 207.

FIG. 11 illustrates a end view of the two-piece conduit rectangular shaped fitting which may include a top curved wall 203 which may include a cover wall 24 and which may be an arched rectangular wall and a bottom curved wall 205 which may be an arched rectangular wall to connect to the top curved wall 203. The top curved wall 203 may include a top flange 21 to connect to a bottom flange 207 of the bottom curved wall 205. The top flange 21 and the bottom flange 207 may include apertures 209 to cooperate with a fastener 22 which may be a screw, bolt or other fastener device to connect the top curved wall 203 with the bottom curved wall 205.

A portion of the interior surface at each end of the top curved wall 203 and the bottom curved wall 205 may include female threads 23 to cooperate with male threads (not shown) of another conduit (not shown). Additionally, an adhesive or o ring 25 may be positioned between the top flange 21 and the bottom flange 207.

FIG. 12 illustrates a front view of the two-piece conduit rectangular shaped fitting which may include a top curved wall 203 which may include a cover wall 24 and which may be an arched rectangular wall and a bottom curved wall 205 which may be an arched rectangular wall to connect to the top curved wall 203. The top curved wall 203 may include a top flange 21 to connect to a bottom flange 207 of the bottom curved wall 205. The top flange 21 and the bottom flange 207 may include apertures 209 to cooperate with a fastener 22 which may be a screw, bolt or other fastener device to connect the top curved wall 203 with the bottom curved wall 205.

A portion of the interior surface at each end of the top curved wall 203 and the bottom curved wall 205 may include female threads 23 to cooperate with male threads (not shown) of another conduit (not shown). Additionally, an adhesive or o ring 25 may be positioned between the top flange 21 and the bottom flange 207.

FIG. 13 illustrates a top view of the two-piece conduit rectangular shaped fitting which may include a top curved wall 203 which may include a cover wall 24 and which may be an arched rectangular wall and a bottom curved wall 205 which may be an arched rectangular wall to connect to the top curved wall 203. The top curved wall 203 may include a top flange 21 to connect to a bottom flange 207 of the bottom curved wall 205. The top flange 21 and the bottom flange 207 may include apertures 209 to cooperate with a fastener 22 which may be a screw, bolt or other fastener device to connect the top curved wall 203 with the bottom curved wall 205.

A portion of the interior surface at each end of the top curved wall 203 and the bottom curved wall 205 may include female threads 23 to cooperate with male threads (not shown) of another conduit (not shown). Additionally, an adhesive or o ring 25 may be positioned between the top flange 21 and the bottom flange 207.

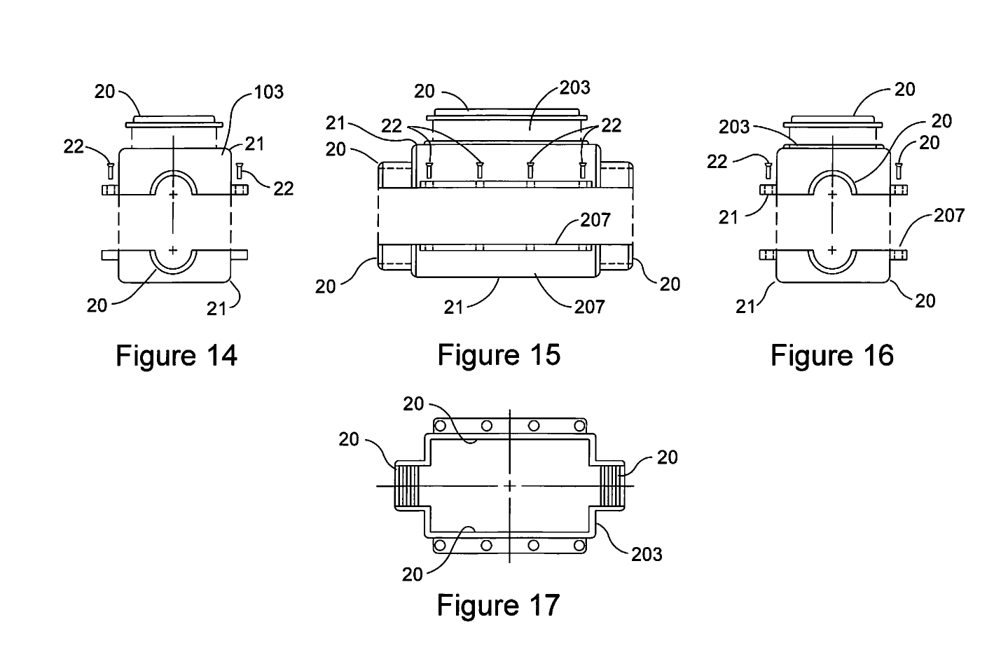

FIG. 14 illustrates an exploded end view of the two-piece conduit rectangular shaped fitting and illustrates the top curved wall 203, the top flange 21, the fasteners 22 the female threads 23, the cover wall 24, the bottom curved wall 205, the bottom flange 207 and the aperture 209.

FIG. 15 illustrates an exploded front view of the two-piece conduit rectangular shaped fitting and illustrates the top curved wall 203, the top flange 21, the fasteners 22 the female threads 23, the cover wall 24, the bottom curved wall 205, the bottom flange 207 and the aperture 209.

FIG. 16 illustrates an exploded front view of the two-piece conduit T-shaped fitting and illustrates the top curved wall 203, the top flange 21, the fasteners 22 the female threads 23, the cover wall 24, the bottom curved wall 205, the bottom flange 207 and the aperture 209.

FIG. 17 illustrates a sectional view of the top curved wall 203, the top flange 21, the female threads 23, and the adhesive or O-ring 25.

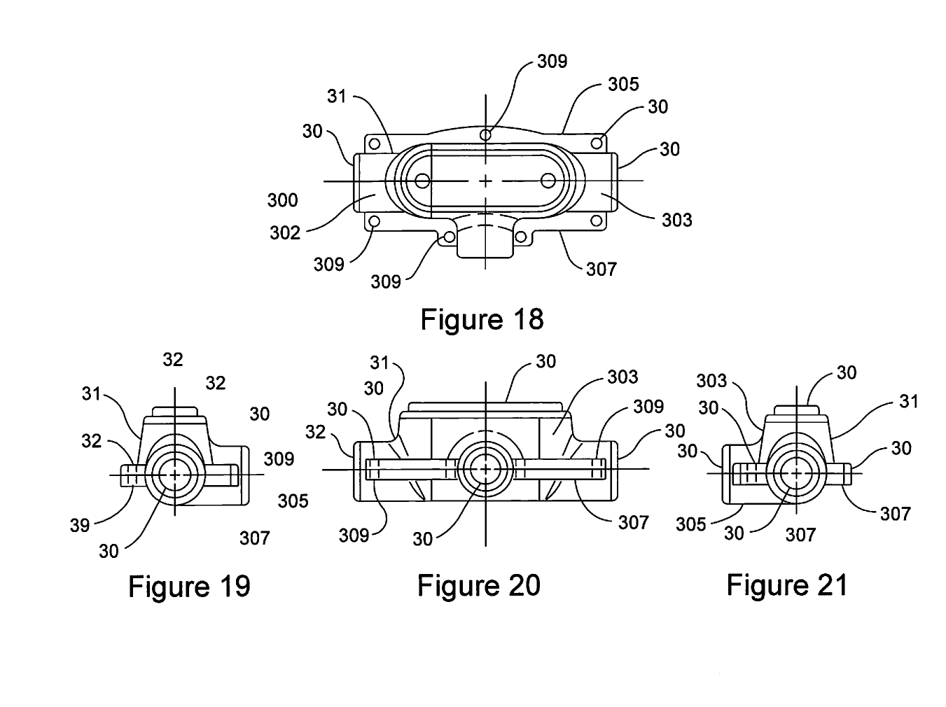

FIG. 18 illustrates a top view of the two-piece conduit T-shaped fitting which may include a top curved wall 303 which may include a cover wall 34 and which may be an arched T-shaped wall and a bottom curved wall 305 which may be an arched T-shaped wall to connect to the top curved wall 303. The housing 300 which may be hollow may define a cavity 302. The top curved wall 303 may include a top flange 31 to connect to a bottom flange 307 of the bottom curved wall 305. The top flange 31 and the bottom flange 307 may include apertures 309 to cooperate with a fastener 32 which may be a screw, bolt or other fastener device to connect the top curved wall 303 with the bottom curved wall 305.

A portion of the interior surface at each end of the top curved wall 303 and the bottom curved wall 305 may include female threads 23 to cooperate with male threads (not shown) of another conduit (not shown). Additionally, an adhesive or o ring 25 may be positioned between the top flange 31 and the bottom flange 307.

FIG. 19 illustrates a end view of the two-piece conduit T-shaped shaped fitting which may include a top curved wall 303 which may include a cover wall 34 and which may be an arched T-shaped r wall and a bottom curved wall 305 which may be an arched T-shaped wall to connect to the top curved wall 303. The top curved wall 303 may include a top flange 31 to connect to a bottom flange 307 of the bottom curved wall 305. The top flange 31 and the bottom flange 307 may include apertures 309 to cooperate with a fastener 32 which may be a screw, bolt or other fastener device to connect the top curved wall 303 with the bottom curved wall 305.

A portion of the interior surface at each end of the top curved wall 303 and the bottom curved wall 305 may include female threads 23 to cooperate with male threads (not shown) of another conduit (not shown). Additionally, an adhesive or o ring 25 may be positioned between the top flange 31 and the bottom flange 307.

FIG. 20 illustrates a front view of the two-piece conduit T-shaped shaped fitting which may include a top curved wall 303 which may include a cover wall 34 and which may be an arched T-shaped wall and a bottom curved wall 305 which may be an arched T-shaped wall to connect to the top curved wall 303. The top curved wall 303 may include a top flange 31 to connect to a bottom flange 307 of the bottom curved wall 305. The top flange 31 and the bottom flange 307 may include apertures 309 to cooperate with a fastener 32 which may be a screw, bolt or other fastener device to connect the top curved wall 303 with the bottom curved wall 305.

A portion of the interior surface at each end of the top curved wall 303 and the bottom curved wall 305 may include female threads 23 to cooperate with male threads (not shown) of another conduit (not shown). Additionally, an adhesive or o ring 25 may be positioned between the top flange 31 and the bottom flange 307.

FIG. 21 illustrates a top view of the two-piece conduit T-shaped fitting which may include a top curved wall 303 which may include a cover wall 34 and which may be an arched T-shaped wall and a bottom curved wall 305 which may be an arched T-shaped wall to connect to the top curved wall 303. The top curved wall 303 may include a top flange 31 to connect to a bottom flange 307 of the bottom curved wall 305. The top flange 31 and the bottom flange 307 may include apertures 309 to cooperate with a fastener 32 which may be a screw, bolt or other fastener device to connect the top curved wall 303 with the bottom curved wall 305.

A portion of the interior surface at each end of the top curved wall 303 and the bottom curved wall 305 may include female threads 23 to cooperate with male threads (not shown) of another conduit (not shown). Additionally, an adhesive or o ring 25 may be positioned between the top flange 31 and the bottom flange 307.

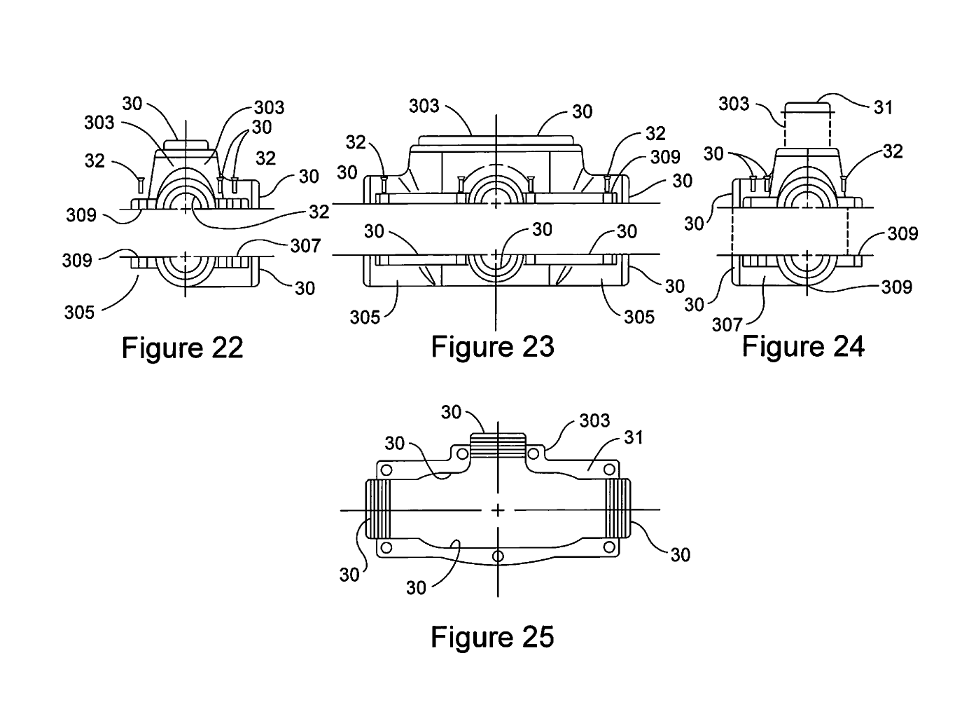

FIG. 22 illustrates an exploded end view of the two-piece conduit T-shaped fitting and illustrates the top curved wall 303, the top flange 31, the fasteners 32 the female threads 23, the cover wall 34, the bottom curved wall 305, the bottom flange 307 and the aperture 309.

FIG. 23 illustrates an exploded front view of the two-piece conduit T-shaped fitting and illustrates the top curved wall 303, the top flange 31, the fasteners 32 the female threads 23, the cover wall 34, the bottom curved wall 305, the bottom flange 307 and the aperture 309.

FIG. 24 illustrates an exploded front view of the two-piece conduit T-shaped fitting and illustrates the top curved wall 303, the top flange 31, the fasteners 32 the female threads 23, the cover wall 34, the bottom curved wall 305, the bottom flange 307 and the aperture 309.

FIG. 25 illustrates a sectional view of the top curved wall 303, the top flange 31, the female threads 23, and the adhesive or O-ring 25.

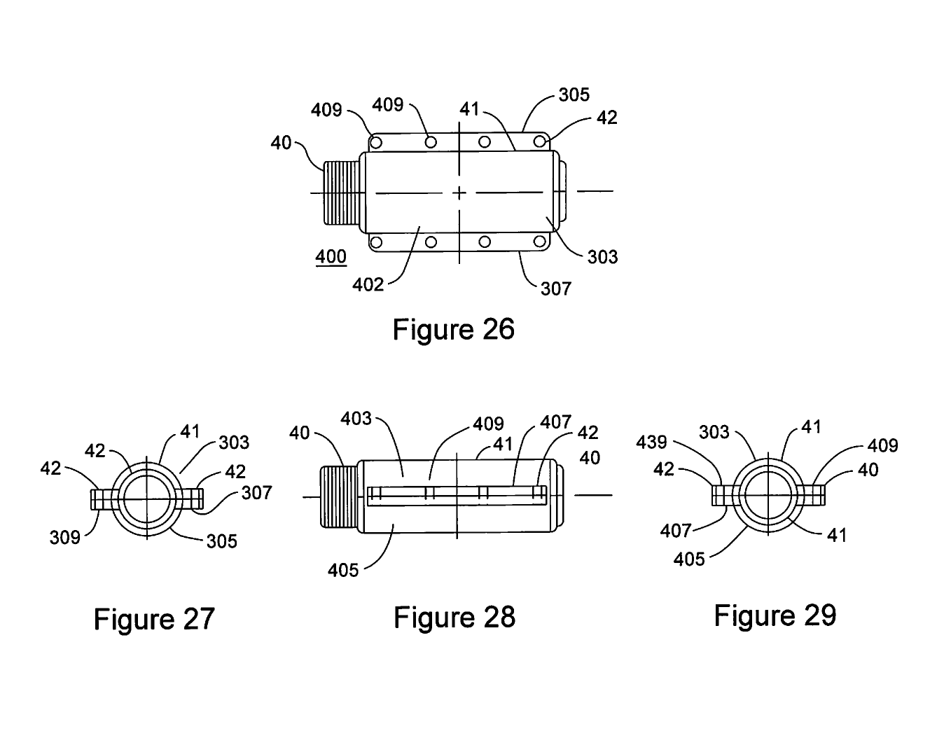

FIG. 26 illustrates a top view of the two-piece conduit with external male threads which may include a top curved wall 403 which may include a cover wall 44 and which may be an arched T-shaped wall and a bottom curved wall 405 which may be an arched T-shaped wall to connect to the top curved wall 403. The housing 400 which may be hollow may define a cavity 402. The top curved wall 403 may include a top flange 41 to connect to a bottom flange 407 of the bottom curved wall 405. The top flange 41 and the bottom flange 407 may include apertures 409 to cooperate with a fastener 42 which may be a screw, bolt or other fastener device to connect the top curved wall 403 with the bottom curved wall 405.

A portion of the interior surface at each end of the top curved wall 403 and the bottom curved wall 405 may include male threads 43 to cooperate with male threads (not shown) of another conduit (not shown). Additionally, an adhesive or o ring 45 may be positioned between the top flange 41 and the bottom flange 407.

FIG. 27 illustrates a end view of the two-piece conduit with external male threads which may include a top curved wall 403 which may include a cover wall 44 and which may be an arched T-shaped r wall and a bottom curved wall 405 which may be an arched T-shaped wall to connect to the top curved wall 403. The top curved wall 403 may include a top flange 41 to connect to a bottom flange 407 of the bottom curved wall 405. The top flange 41 and the bottom flange 407 may include apertures 409 to cooperate with a fastener 42 which may be a screw, bolt or other fastener device to connect the top curved wall 403 with the bottom curved wall 405.

A portion of the interior surface at each end of the top curved wall 403 and the bottom curved wall 405 may include male threads 43 to cooperate with male threads (not shown) of another conduit (not shown). Additionally, an adhesive or o ring 45 may be positioned between the top flange 41 and the bottom flange 407.

FIG. 28 illustrates a front view of the two-piece conduit with external male threads which may include a top curved wall 403 which may include a cover wall 44 and which may be an arched T-shaped wall and a bottom curved wall 405 which may be an arched T-shaped wall to connect to the top curved wall 403. The top curved wall 403 may include a top flange 41 to connect to a bottom flange 407 of the bottom curved wall 405. The top flange 41 and the bottom flange 407 may include apertures 409 to cooperate with a fastener 42 which may be a screw, bolt or other fastener device to connect the top curved wall 403 with the bottom curved wall 405.

A portion of the interior surface at each end of the top curved wall 403 and the bottom curved wall 405 may include male threads 43 to cooperate with male threads (not shown) of another conduit (not shown). Additionally, an adhesive or o ring 45 may be positioned between the top flange 41 and the bottom flange 407.

FIG. 29 illustrates a top view of the two-piece conduit with external male threads which may include a top curved wall 403 which may include a cover wall 44 and which may be an arched T-shaped wall and a bottom curved wall 405 which may be an arched T-shaped wall to connect to the top curved wall 403. The top curved wall 403 may include a top flange 41 to connect to a bottom flange 407 of the bottom curved wall 405. The top flange 41 and the bottom flange 407 may include apertures 409 to cooperate with a fastener 42 which may be a screw, bolt or other fastener device to connect the top curved wall 403 with the bottom curved wall 405.

A portion of the interior surface at each end of the top curved wall 403 and the bottom curved wall 405 may include male threads 43 to cooperate with male threads (not shown) of another conduit (not shown). Additionally, an adhesive or o ring 45 may be positioned between the top flange 41 and the bottom flange 407.

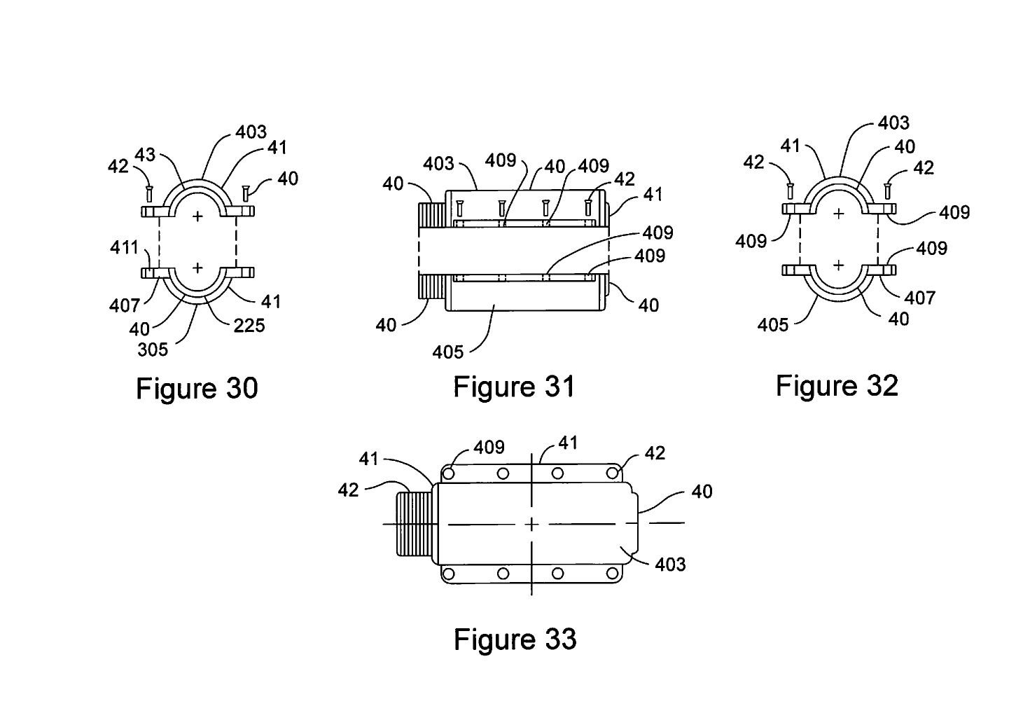

FIG. 30 illustrates an exploded end view of the two-piece conduit with external male threads and illustrates the top curved wall 403, the top flange 41, the fasteners 42 the male threads 43, the cover wall 44, the bottom curved wall 405, the bottom flange 407 and the aperture 409.

FIG. 31 illustrates an exploded front view of the two-piece conduit with external male threads and illustrates the top curved wall 403, the top flange 41, the fasteners 42 the male threads 43, the cover wall 44, the bottom curved wall 405, the bottom flange 407 and the aperture 409.

FIG. 32 illustrates an exploded front view of the two-piece conduit with external male threads and illustrates the top curved wall 403, the top flange 41, the fasteners 42 the male threads 43, the cover wall 44, the bottom curved wall 405, the bottom flange 407 and the aperture 409.

FIG. 33 illustrates a sectional view of the top curved wall 403, the top flange 41, the male threads 43, and the adhesive or O-ring 45.

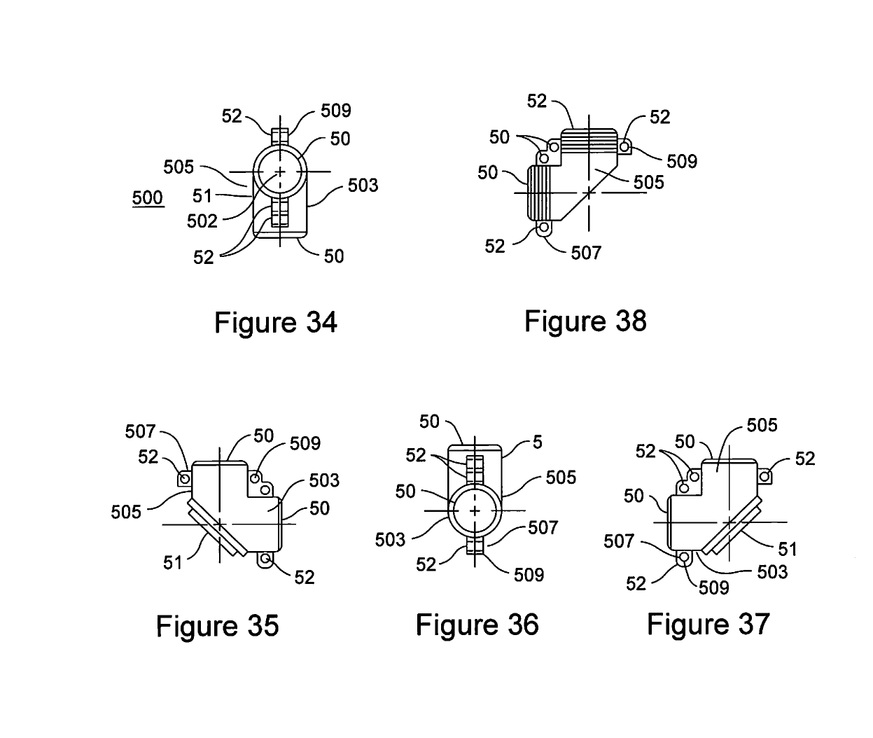

FIG. 34 illustrates a top view of the two-piece conduit elbow fitting which may include a top curved wall 503 which may include a cover wall 54 and which may be an arched L-shaped wall and a bottom curved wall 505 which may be an arched L-shaped wall to connect to the top curved wall 503. The housing 500 which may be hollow may define a cavity 502. The top curved wall 503 may include a top flange 51 to connect to a bottom flange 507 of the bottom curved wall 505. The top flange 51 and the bottom flange 507 may include apertures 509 to cooperate with a fastener 52 which may be a screw, bolt or other fastener device to connect the top curved wall 503 with the bottom curved wall 505.

A portion of the interior surface at each end of the top curved wall 503 and the bottom curved wall 505 may include male threads 53 to cooperate with male threads (not shown) of another conduit (not shown). Additionally, an adhesive or o ring 45 may be positioned between the top flange 51 and the bottom flange 507.

FIG. 35 illustrates a top view of the two-piece conduit elbow fitting which may include a top curved wall 503 which may include a cover wall 54 and which may be an arched L-shaped wall and a bottom curved wall 505 which may be an arched L-shaped wall to connect to the top curved wall 503. The top curved wall 503 may include a top flange 51 to connect to a bottom flange 507 of the bottom curved wall 505. The top flange 51 and the bottom flange 507 may include apertures 509 to cooperate with a fastener 52 which may be a screw, bolt or other fastener device to connect the top curved wall 503 with the bottom curved wall 505.

A portion of the interior surface at each end of the top curved wall 503 and the bottom curved wall 505 may include male threads 53 to cooperate with male threads (not shown) of another conduit (not shown). Additionally, an adhesive or o ring 45 may be positioned between the top flange 51 and the bottom flange 507.

FIG. 36 illustrates a front view of the two-piece conduit elbow fitting which may include a top curved wall 503 which may include a cover wall 54 and which may be an arched L-shaped wall and a bottom curved wall 505 which may be an arched L-shaped wall to connect to the top curved wall 503. The top curved wall 503 may include a top flange 51 to connect to a bottom flange 507 of the bottom curved wall 505. The top flange 51 and the bottom flange 507 may include apertures 509 to cooperate with a fastener 52 which may be a screw, bolt or other fastener device to connect the top curved wall 503 with the bottom curved wall 505.

A portion of the interior surface at each end of the top curved wall 503 and the bottom curved wall 505 may include male threads 53 to cooperate with male threads (not shown) of another conduit (not shown). Additionally, an adhesive or o ring 45 may be positioned between the top flange 51 and the bottom flange 507.

FIG. 37 illustrates a bottom view of the two-piece conduit elbow fittings which may include a top curved wall 503 which may include a cover wall 54 and which may be an arched L-shaped wall and a bottom curved wall 505 which may be an arched L-shaped wall to connect to the top curved wall 503. The top curved wall 503 may include a top flange 51 to connect to a bottom flange 507 of the bottom curved wall 505. The top flange 51 and the bottom flange 507 may include apertures 509 to cooperate with a fastener 52 which may be a screw, bolt or other fastener device to connect the top curved wall 503 with the bottom curved wall 505.

A portion of the interior surface at each end of the top curved wall 503 and the bottom curved wall 505 may include male threads 53 to cooperate with male threads (not shown) of another conduit (not shown). Additionally, an adhesive or o ring 45 may be positioned between the top flange 51 and the bottom flange 507.

FIG. 38 illustrates a sectional view of the top curved wall 503, the top flange 51, the male threads 53, and the adhesive or O-ring 45.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A conduit for protecting wires, comprising:
an only top curved wall; and
an only bottom curved wall being connected to the top curved wall to define a housing for the conduit and having a cavity.

2. A conduit for protecting wires as in claim 1, wherein the top curved wall includes a top flange.

3. A conduit for protecting wires as in claim 1, wherein the bottom curved wall includes a bottom flange.

4. A conduit for protecting wires as in claim 1, wherein the top curved wall is substantially L-shaped.

5. A conduit for protecting wires as in claim 1, wherein the top curved wall is substantially T-shaped.

6. A conduit for protecting wires as in claim 1, wherein the top curved wall is substantially rectangular.

7. A conduit for protecting wires as in claim 1, wherein the bottom curved wall is substantially L-shaped.

8. A conduit for protecting wires as in claim 1, wherein the bottom curved wall is substantially T-shaped.

9. A conduit for protecting wires as in claim 1, wherein the bottom curved wall is substantially rectangular.
